(19) United States
(12) Patent Application Publication
(10) Pub. No.: US 2016/0309115 A1
(43) Pub. Date: Oct. 20, 2016

(54) VIDEOPHONE AND CAMERA ASSEMBLY

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: SHU-QI WU, Wuhan (CN); YONG-CHANG FAN, Wuhan (CN); YU-LIN LIU, Wuhan (CN)

(21) Appl. No.: 14/716,189

(22) Filed: May 19, 2015

(30) Foreign Application Priority Data
Apr. 17, 2015 (CN) 201510183267.3

(51) Int. Cl. H04N 7/14; H04N 5/225

(52) U.S. Cl. CPC H04N 7/141; H04N 5/2251

(57) ABSTRACT

A videophone includes a camera, a deflecting plate, and a driving device. The camera is located on the deflecting plate. The deflecting plate includes a shaft. The camera includes a supporting post. The supporting post is substantially perpendicular to the shaft. The driving device can drive the supporting post and the shaft to rotate. The camera can rotate about the supporting post and the shaft to adjust angle of the camera. A camera assembly is also provided.

### CROSS-REFERENCE TO RELATED APPLICATIONS

This application claims priority to Chinese Patent Application No. 201510183267.3 filed on Apr. 17, 2015, the contents of which are incorporated by reference herein.

### FIELD

The subject matter herein generally relates to a videophone and a camera assembly.

### BACKGROUND

A videophone usually includes a camera. A user can use the camera to share videos with others. However, sometimes the camera is stationary and cannot capture a user moving away from the camera.

### BRIEF DESCRIPTION OF THE DRAWINGS

Implementations of the present technology will now be described, by way of example only, with reference to the attached figures.

FIG. 1 is an isometric view of one embodiment of a videophone.

FIG. 2 is an exploded, isometric view of the videophone of FIG. 1.

FIG. 3 is an assembled, isometric view of the videophone of FIG. 2.

FIG. 4 is a cross-sectional view in the videophone taken along line IV-IV of FIG. 3.

FIG. 5 is similar to FIG. 3, but a camera of the videophone is in a second position.

FIG. 6 is similar to FIG. 5, but the camera of the videophone is in third position.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising” when utilized, means “including, but not necessarily limited to”; it specifically indicates open-ended inclusion or membership in the so-described combination, group, series and the like.

The present disclosure is described in relation to a videophone.

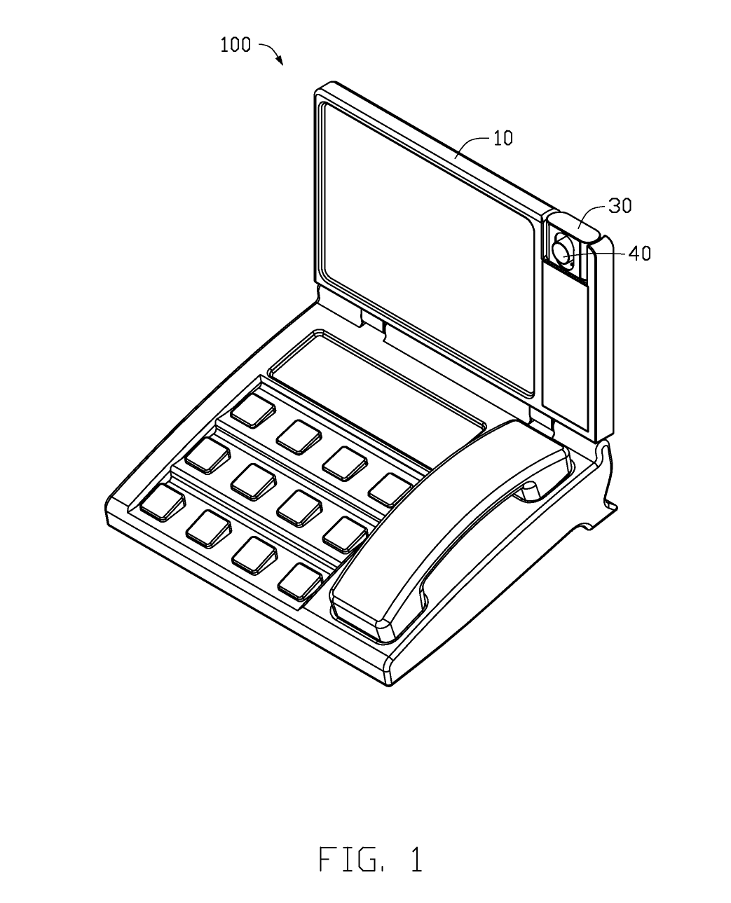

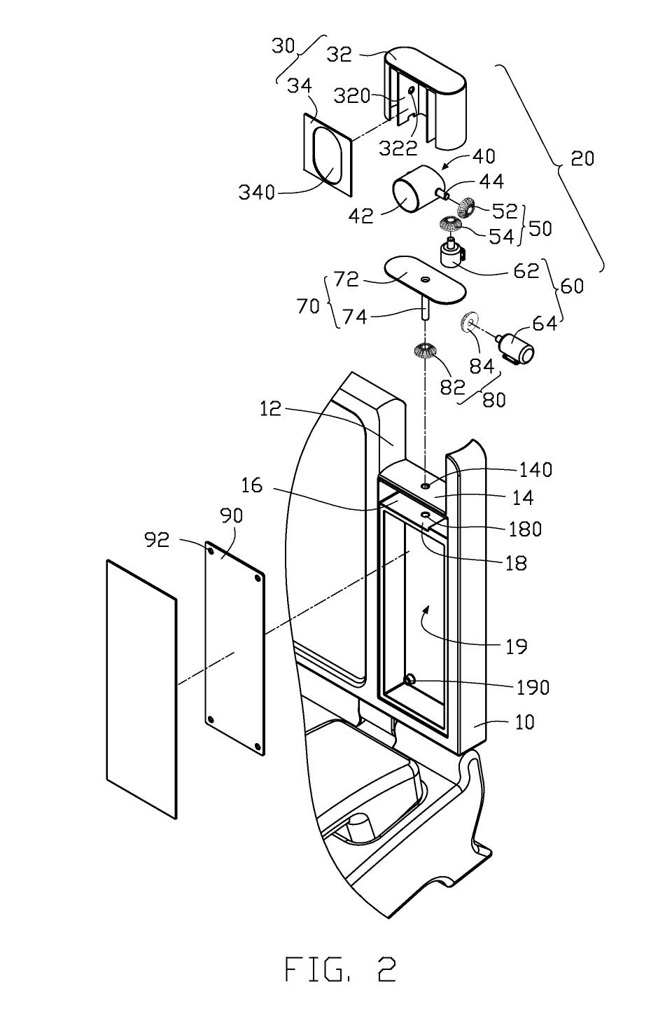

FIGS. 1-2 illustrate one embodiment of a videophone 100. The videophone 100 includes a frame 10, a camera module 20, and a control panel 90.

The frame 10 defines an opening 12, a mounting groove 16, and a receiving space 19. The frame 10 includes a first plate 14 and a second plate 18. The first plate 14 is located between the opening 12 and the mounting groove 16. The second plate 18 is located between the mounting groove 16 and the receiving space 19. The first plate 14 defines a through hole 140. The second plate 18 defines a shaft hole 180. The receiving space 19 includes four fixing posts 190. In one embodiment, the frame 10 can be substantially rectangular.

The camera module 20 includes a shell 30, a camera 40, a first transmission element 50, a driving device 60, a deflecting plate 70, and a second transmission element 80. The shell 30 includes a main portion 32 and a panel 34. The main portion 32 includes two supporting plates 320. In one embodiment, the two supporting plates 320 can be substantially parallel to each other. Each supporting plate 320 defines a mounting hole 322. The panel 34 defines a receiving hole 340. In one embodiment, the receiving hole 340 can be substantially elliptic. The camera 40 includes a body 42 and two supporting posts 44. The two supporting posts 44 extend from two sides of the body 42. A cross section of the receiving hole 340 is greater than a cross section of the main portion 32. The first transmission element 50 includes a first gear 52 and a second gear 54. The driving device 60 includes a first motor 62 and a second motor 64. The deflecting plate 70 includes a mounting plate 72 and a shaft 74. In one embodiment, the shaft 74 extends from the mounting plate 72 and can be substantially perpendicular to the mounting plate 72. The deflecting plate 70 can be substantially T-shaped. The second transmission element 80 includes a third gear 82 and a forth gear 84. The control panel 90 defines four fixing holes 92.

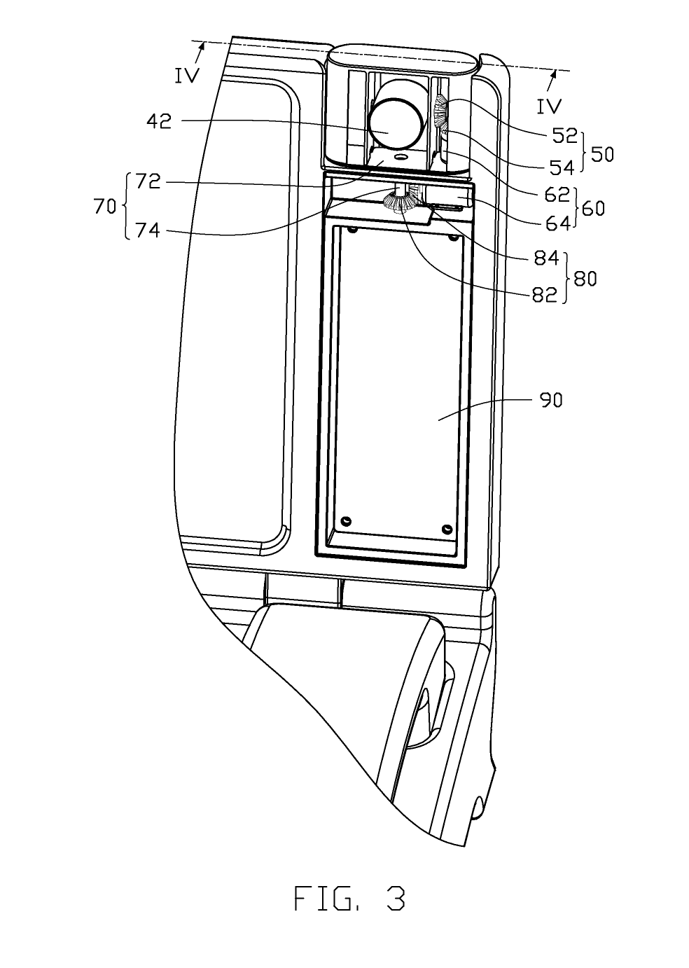

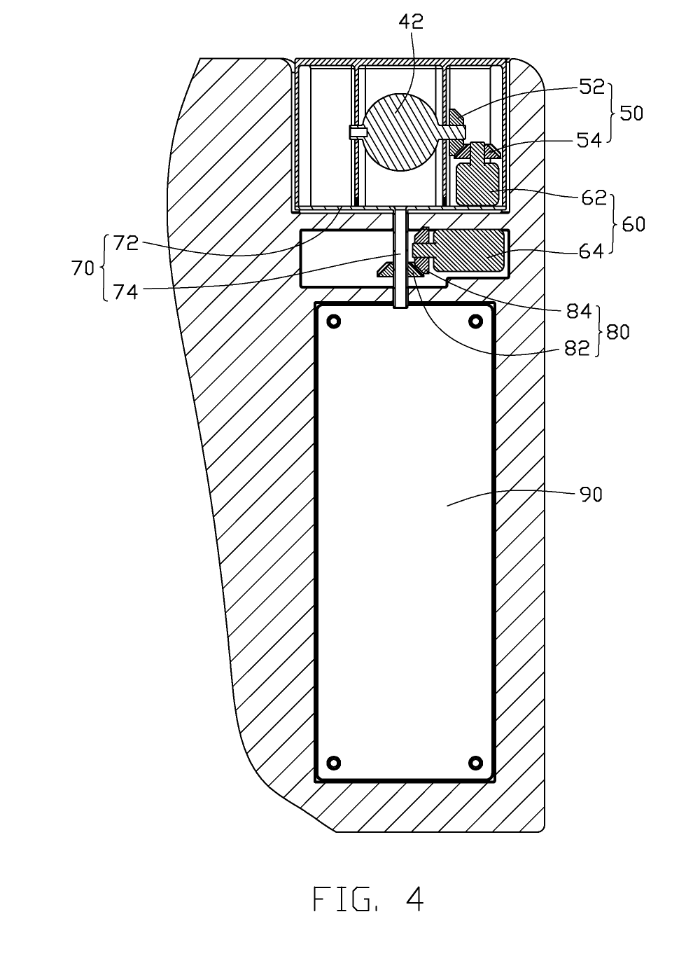

FIGS. 3-4 illustrate the videophone 100 assembled. The four fixing holes 92 are engaged with the four fixing posts 190. The control panel 90 is mounted in the receiving space 19. The shaft 74 of the deflecting plate 70 passes through the through hole 140. The third gear 82 is fixed to the shaft 74. The shaft 74 is received in the shaft hole 180. The second motor 64 is fixed on the second plate 18. The forth gear 84 is fixed to one end of the second motor 64.

The third gear 82 is engaged with the forth gear 84. In one embodiment, the third gear 82 can be substantially perpendicular to the forth gear 84. The two supporting posts 44 are engaged with the two mounting holes 322. The camera 40 is rotatably fixed to the shell 30. The first gear 52 is fixed to one of the two supporting posts 44. The first motor 62 is fixed to the main portion 32. The second gear 54 is fixed to one end of the first motor 62. The first gear 52 is engaged with the second gear 54. In one embodiment, the first gear 52 can be substantially perpendicular to the second gear 54. The panel 34 is fixed to the main portion 32. The body 42 of the camera 40 extends through the receiving hole 340. The shell 30 is received in the opening 12 and located on the mounting plate 72. The camera 40 is located on a corner of the frame 10. The control panel 90 is electrically connected to the driving device 60 and can control the driving device 60.

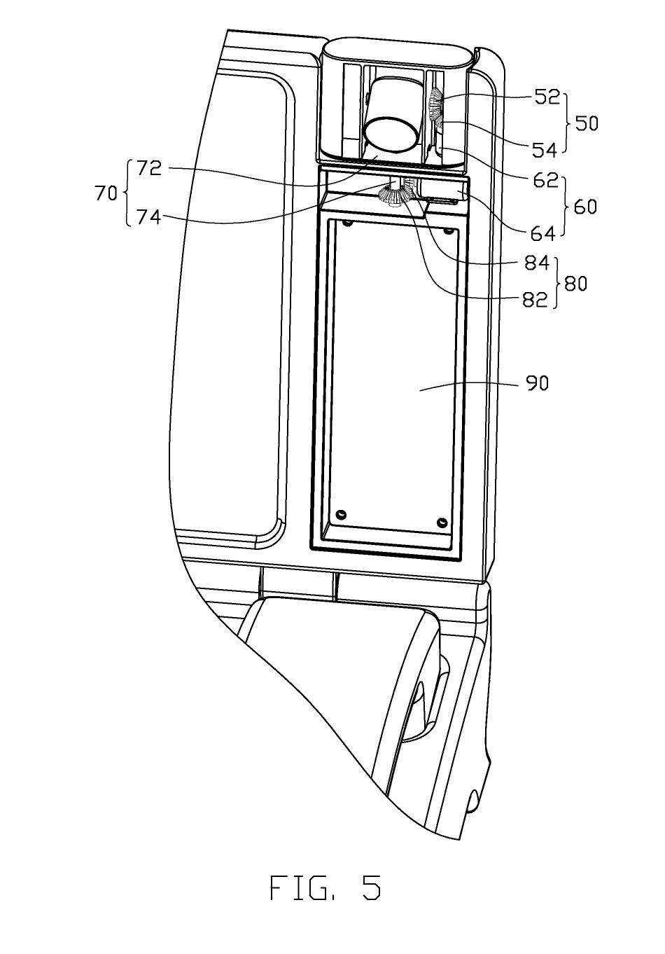

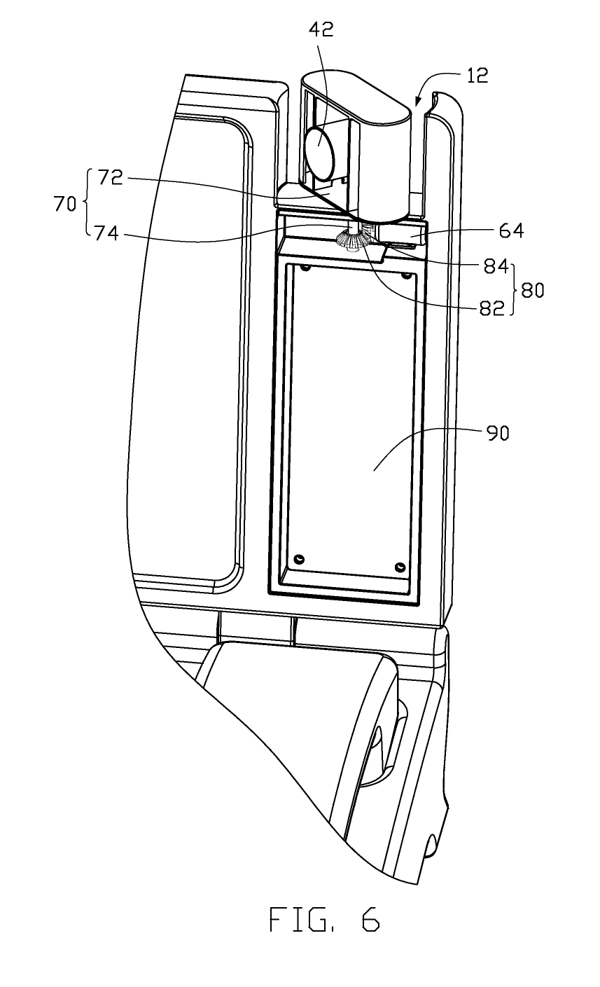

FIGS. 5-6 illustrate the videophone 100 in a working state. The first motor 62 is controlled by the control panel 90, to rotate. The second gear 54 rotates with the first motor 62. The camera 40 is driven to rotate by the second gear 54 via the first gear 52. The body 42 moves within the receiving hole 340. The control panel 90 can control the second motor 64 to rotate. The forth gear 84 rotates driven by the second motor 64. The shaft 74 is driven to rotate by the forth gear 84 via the third gear 82. The shell 30 and the mounting plate 72 rotate within the opening 12. When the control panel 90 controls the first motor 62 and the second motor 64, the camera 40 can be adjusted to different angles.

The embodiments shown and described above are only examples. Many details are often found in the art such as the other features of a videophone. Therefore, many such details are neither shown nor described. Even though numerous characteristics and advantages of the present technology have been set forth in the foregoing description, together with details of the structure and function of the present disclosure, the disclosure is illustrative only, and changes may be made in the details, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A videophone comprising:
a deflecting plate comprising a shaft;
a camera located on the deflecting plate and comprising a supporting post substantially perpendicular to the shaft; and
a driving device coupled to the deflecting plate and configured to drive the supporting post and the shaft to rotate, and the camera is configured to rotate about the supporting post and the shaft to adjust capture angle of the camera.

2. The videophone of claim 1, wherein the deflecting plate comprises a mounting plate, the shaft is substantially perpendicular to the mounting plate, and the camera is located on the mounting plate.

3. The videophone of claim 2, wherein the deflecting plate is substantially T-shaped.

4. The videophone of claim 3, further comprising a frame, wherein the frame defines an opening and comprises a first plate, the mounting plate and the camera are received in the opening and located on the first plate, and the shaft is rotatably fixed to the first plate.

5. The videophone of claim 4, further comprising a first transmission element, wherein the driving device comprises a first motor, the first motor is located on the mounting plate and rotates with the deflecting plate, the first transmission element is fixed to the first motor and the supporting post, and the supporting post is driven by the first motor.

6. The videophone of claim 5, wherein the first transmission element comprises a first gear and a second gear, the first gear is fixed to the supporting post, the second gear is fixed to the first motor, the first gear is engaged with the second gear, and the first gear is substantially perpendicular to the second gear.

7. The videophone of claim 4, further comprising a second transmission element, wherein the frame further defines a mounting groove, the driving device comprises a second motor, the shaft, the second transmission element, and the second motor are received in the mounting groove, the second transmission element is fixed to the shaft and the second motor, and the shaft is driven by the second motor.

8. The videophone of claim 7, wherein the second transmission element comprises a third gear and a forth gear, the third gear is fixed to the shaft, the forth gear is fixed to the second motor, the third gear is engaged with the forth gear, and the third gear is substantially perpendicular to the forth gear.

9. The videophone of claim 1, further comprising a control panel, wherein the control panel is electrically connected to the driving device, and the control panel is configured to adjust angle of the camera via the driving device.

10. The videophone of claim 1, further comprising a frame, wherein the frame is substantially rectangular, and the camera is located on a corner of the frame.

11. A camera assembly comprising:
a deflecting plate comprising a shaft;
a camera located on the deflecting plate, the camera comprising a supporting post; and
a driving device;
wherein the supporting post is substantially perpendicular to the shaft, the driving device is configured to drive the supporting post and the shaft to rotate, and the camera is configured rotate about the supporting post and the shaft to adjust capture angle of the camera.

12. The camera assembly of claim 11, wherein the deflecting plate comprises a mounting plate, the shaft is substantially perpendicular to the mounting plate, and the camera is located on the mounting plate.

13. The camera assembly of claim 12, wherein the deflecting plate is substantially T-shaped.

14. The camera assembly of claim 13, further comprising a frame, wherein the frame defines an opening and comprises a first plate, the mounting plate and the camera are received in the opening and located on the first plate, and the shaft is rotatably fixed to the first plate.

15. The camera assembly of claim 14, further comprising a first transmission element, wherein the driving device comprises a first motor, the first motor is located on the mounting plate and rotates with the deflecting plate, the first transmission element is fixed with the first motor and the supporting post, and the supporting post is driven by the first motor.

16. The camera assembly of claim 15, wherein the first transmission element comprises a first gear and a second gear, the first gear is fixed to the supporting post, the second gear is fixed to the first motor, the first gear is engaged with the second gear, and the first gear is substantially perpendicular to the second gear.

17. The camera assembly of claim 14, further comprising a second transmission element, wherein the frame further defines a mounting groove, the driving device comprises a second motor, the shaft, the second transmission element, and the second motor are received in the mounting groove, the second transmission element is fixed to the shaft and the second motor, and the shaft is driven by the second motor.

18. The camera assembly of claim 17, wherein the second transmission element comprises a third gear and a forth gear, the third gear is fixed to the shaft, the forth gear is fixed to the second motor, the third gear is engaged with the forth gear, and the third gear is substantially perpendicular to the forth gear.

19. The camera assembly of claim 11, further comprising a control panel, wherein the control panel is electrically connected to the driving device, and the control panel is configured to adjust angle of the camera via the driving device.

20. The camera assembly of claim 11, further comprising a frame, wherein the frame is substantially rectangular, and the camera is located on a corner of the frame.
